(19) United States
(12) Patent Application Publication
(10) Pub. No.: US 2018/0290905 A1
(43) Pub. Date: Oct. 11, 2018

(54) DEVICE FOR PRODUCING ELECTROLYZED WATER

(71) Applicant: Molex, LLC, Lisle, IL (US)

(72) Inventors: Kousuke TAKETOMI, Yamato (JP); Megumi MURAMOTO, Yamato (JP)

(73) Assignee: Molex, LLC, Lisle, IL (US)

(21) Appl. No.: 15/766,233

(22) PCT Filed: Sep. 8, 2016
(86) PCT No.: PCT/US16/50722

§ 371 Date: Apr. 5, 2018

(30) Foreign Application Priority Data
Oct. 8, 2015 (JP) 2015-200407

(51) Int. Cl. C02F 1/461

(52) U.S. Cl. CPC C02F 1/4618; C02F 2301/08; C02F 2201/4611; C02F 2201/46115

(57) ABSTRACT

The primary electrolyzer includes a first cathode and a first anode. The secondary electrolyzer includes a plurality of second cathodes and a plurality of second anodes, and an electrode housing case with an opening for housing the second cathodes and the second anodes. The anode chamber case is pressure joined with the opening formed in the secondary electrolyzer. Both the primary cathode and the first anode are provided so as to be parallel to the pressure joined surface between the anode chamber case and the opening. The second cathodes and second anodes are provided so that the edges of the second electrodes face the outlet for the primary electrolyzed water in the primary electrolyzer.

### RELATED APPLICATIONS

This application claims priority to Japanese Application No. 2015-200407, filed Oct. 8, 2015, which is incorporated herein by reference in its entirety.

### TECHNICAL FIELD

The present disclosure relates to a device for producing electrolyzed water.

### BACKGROUND ART

There are devices for producing acidic electrolyzed water and alkaline electrolyzed water as described in Patent Document 1.

Patent Document 1: Laid-Open Patent Publication No. 2000-246249

### SUMMARY

The applicants have studied a device for producing electrolyzed water in which high-quality electrolyzed water (secondary electrolyzed water) is produced by obtaining primary electrolyzed water by performing electrolysis on raw water and a chlorine-based electrolyte aqueous solution in a primary electrolyzer, and then electrolyzing the primary electrolyzed water or electrolyzing the primary electrolyzed water contained added alkaline electrolyzed water in a secondary electrolyzer.

The case components constituting the primary electrolyzer and secondary electrolyzer are arranged in parallel, and the adjacent case components are pressure joined to each other to complete a device for producing secondary electrolyzed water. At this time, the internal components such as the electrodes are arranged parallel to the case components, and housed inside the primary electrolyzer and the second electrolyzer.

In this configuration, the electrodes housed inside the secondary electrolyzer become inclined between the electrode nearest to the primary electrolyzer and the electrode farthest from the first electrode due to the electrolysis conditions and this causes the production efficiency of the secondary electrolyzer to decline.

The present disclosure provides a device for producing electrolyzed water with an integrated primary electrolyzer and secondary electrolyzer in which the primary electrolyzer and the secondary electrolyzer can be easily sealed while maintaining efficient production of electrolyzed water.

In order to overcome the foregoing, the present disclosure is a device for producing electrolyzed water comprising: a primary electrolyzer for obtaining acidic primary electrolyzed water by performing electrolysis on raw water and a chlorine-based electrolyte aqueous solution, and a secondary electrolyzer for obtaining secondary electrolyzed water by performing electrolysis on the primary electrolyzed water or by performing electrolysis on primary electrolyzed water to which alkaline electrolyzed water has been added, the primary electrolyzer comprising a plurality of first electrodes for electrolyzing the raw water and chlorine-based electrolyte aqueous solution, the secondary electrolyzer comprising a plurality of second electrodes for electrolyzing the primary electrolyzed water or primary electrolyzed water to which alkaline electrolyzed water has been added, an outer wall of the primary electrolyzer being pressure joined with an open portion formed in the second electrolyzer, each of the first electrodes being provided parallel to the pressure joined surface of the outer wall of the primary electrolyzer and the open portion, and each of the second electrodes being provided so that the edges of the second electrodes face the outlet for the primary electrolyzed water in the primary electrolyzer.

In one aspect of the present disclosure, each of the second electrodes are provided so that the normal direction of the electrode surface is the direction perpendicular to the vertical direction, and the direction perpendicular to the pressure joining direction of the outer wall of the primary electrolyzer and the open portion.

In another aspect of the present disclosure, the first electrode in the position closest to the outer wall is an anode.

In another aspect of the present disclosure, grooves for engaging the edges of the second electrodes are formed in the open ended surface of a guiding portion accommodated in the outer wall of the primary electrolyzer for guiding the primary electrolyzed water into the secondary electrolyzer.

In this aspect of the present disclosure, the grooves are formed at a predetermined interval.

### BRIEF DESCRIPTION OF THE DRAWINGS

FIG. 1A is an exploded perspective view of some of the internal components in a device for producing electrolyzed water according to the present disclosure.

FIG. 1B is an exploded perspective view of the remaining internal components in the device for producing electrolyzed water according to the present disclosure.

FIG. 2 is an external perspective view of a device for producing electrolyzed water according to the present disclosure in which the outer cases have been removed.

FIG. 3 is an external perspective view of a device for producing electrolyzed water according to the present disclosure in which the outer cases are attached.

FIG. 4A is a cross-sectional view of a device for producing electrolyzed water according to the present disclosure in which the outer cases have been removed.

FIG. 4B is a partial enlarged cross-sectional view of a device for producing electrolyzed water according to the present disclosure in which the outer cases have been removed.

FIG. 5 is a perspective view showing the anode chamber case housing a guide panel.

FIG. 6A is an exploded perspective view of the anode chamber case and guide panel shown in FIG. 5.

FIG. 6B is an exploded perspective view of the cathode chamber case and the guide panel shown in FIG. 5 from a direction other than the one shown in FIG. 6A.

FIG. 7 is a drawing used to explain the flow path of the primary electrolyzed water.

FIG. 8 is a drawing showing the chemical equilibrium formula for the secondary electrolyzed water produced by a device for producing electrolyzed water according to the present disclosure.

FIG. 9 is an external perspective view of a device for producing electrolyzed water according to another embodiment of the present disclosure.

FIG. 10 is a cross-sectional view of a device for producing electrolyzed water according to another embodiment of the present disclosure.

### DETAILED DESCRIPTION OF THE PREFERRED EMBODIMENTS

The following is an explanation of an embodiment of the present disclosure with reference to the drawings.

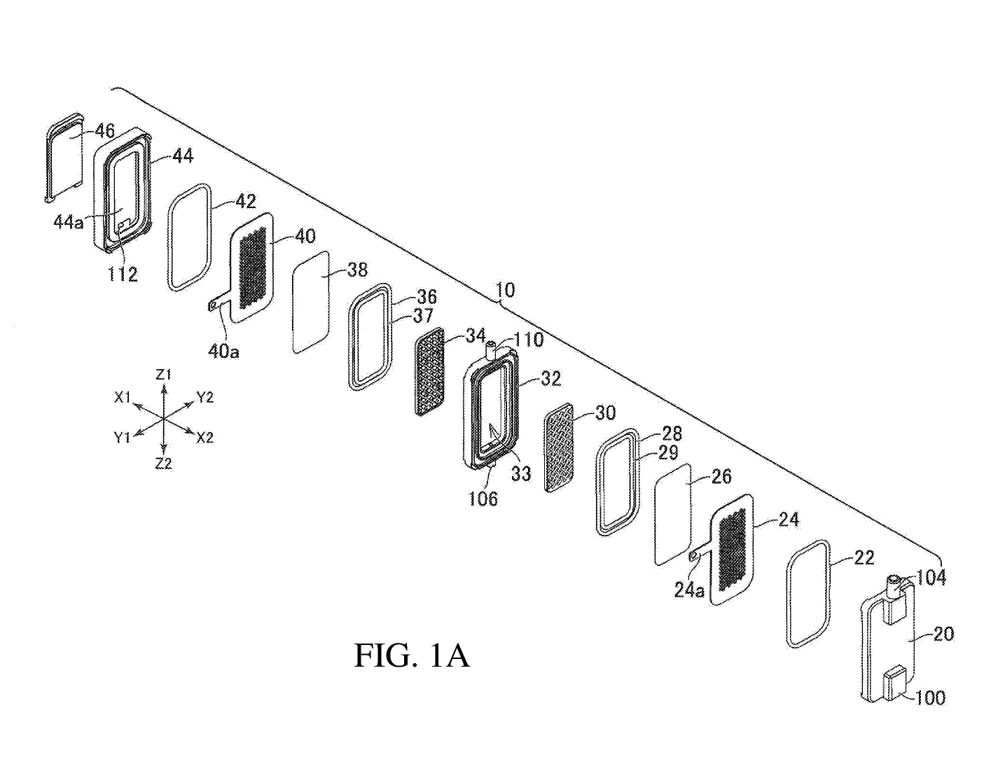

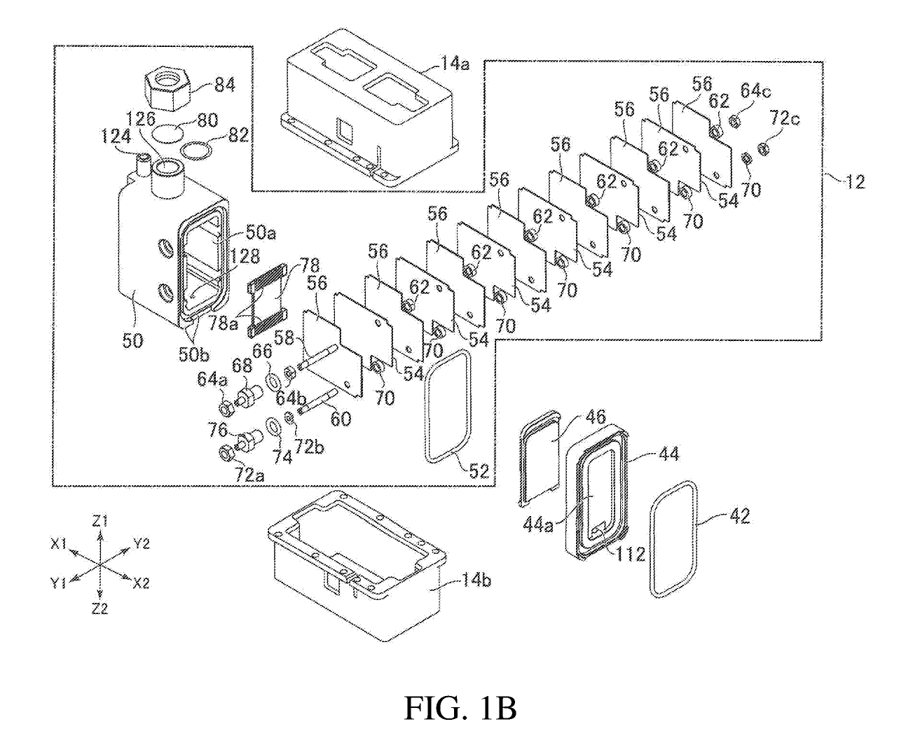

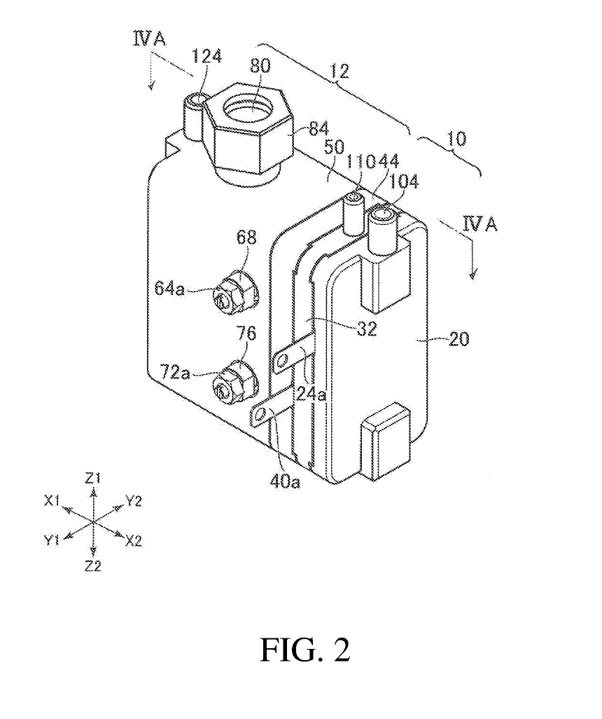

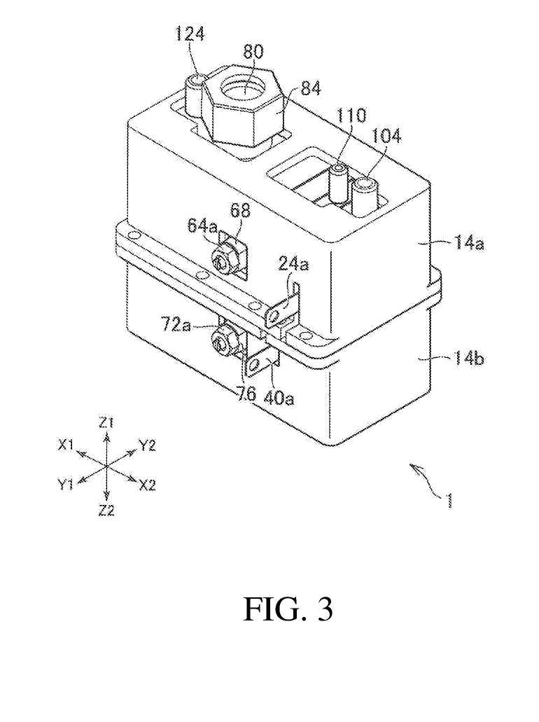

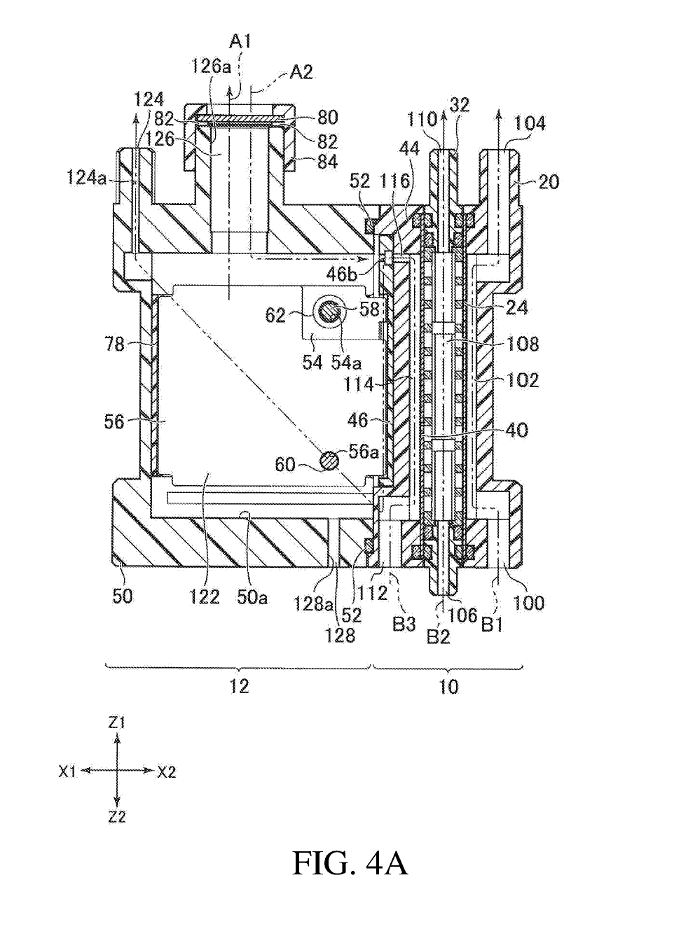

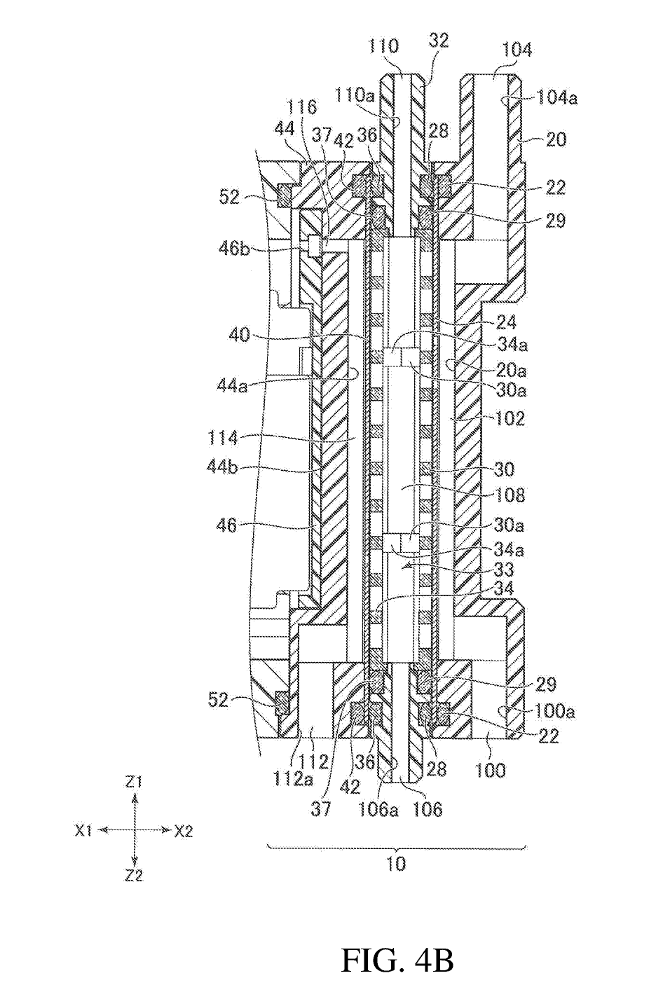

FIG. 1A is an exploded perspective view of some of the internal components in a device for producing electrolyzed water according to the present disclosure. FIG. 1B is an exploded perspective view of the remaining internal components in the device for producing electrolyzed water according to the present disclosure. In order to explain the overall structure more easily, the gasket 42, anode chamber case 44, and guide panel 46 described below are shown in each drawing. FIG. 2 is an external perspective view of a device for producing electrolyzed water according to the present disclosure in which the outer cases 14a, 14b have been removed. FIG. 3 is an external perspective view of a device for producing electrolyzed water according to the present disclosure in which the outer cases 14a, 14b are attached. FIG. 4A is a cross-sectional view of a device for producing electrolyzed water according to the present disclosure in which the outer cases 14a, 14b have been removed. FIG. 4B is a partial enlarged cross-sectional view of a device for producing electrolyzed water according to the present disclosure in which the outer cases 14a, 14b have been removed.

In the following explanation, the direction of the opening in the electrode housing case 50 shown as a box-shaped case with a bottom in FIG. 1B is the right direction (X2 direction), and the opposite direction is the left direction (X1 direction). The direction of the front surface is the front direction (Y1 direction), and the opposite direction is the rear direction (Y2 direction). The direction of the top surface is the up direction (Z1 direction), and the opposite direction is the down direction (Z2 direction).

The production device 1 in the present embodiment includes a primary electrolyzer 10, secondary electrolyzer 12, outer case 14a, and outer case 14b. Outer case 14a and outer case 14b are made of resin. In the present embodiment, the primary electrolyzer 10 and the secondary electrolyzer 12 are integrated. As shown in FIG. 3, they are housed inside outer case 14a and outer case 14b, and completely sealed.

The following is an explanation of the primary electrolyzer 10.

The primary electrolyzer 10 includes a sheet-like cathode chamber case 20 made of a resin. A cathode chamber recessed portion 20a is formed in the center of the left surface of the cathode chamber case 20 to serve as the inner wall of the cathode chamber 102. A cathode chamber outlet 104 protrudes in the upper central portion of the right surface of the cathode chamber case 20, and a discharge passage 104a is formed inside the cathode chamber outlet 104 to the upper central portion of the cathode chamber recessed portion 20a, Similarly, a cathode chamber inlet 100 protrudes in the lower central portion of the right surface of the cathode chamber case 20, and an intake passage 100a is formed inside the cathode chamber inlet 100 to the lower central portion of the cathode chamber recessed portion 20a.

A groove is formed in the peripheral edge of the cathode chamber recessed portion 20a formed in the left surface of the cathode chamber case 20, and a gasket 22 is accommodated inside the groove. A sheet-like first cathode 24 is arranged on the left surface of the cathode chamber case 20 so as to cover the cathode chamber recessed portion 20a and the gasket 22.

A tab-like terminal 24a is formed in the first cathode 24 so as to protrude forward. Mesh-like holes are also formed in the first cathode 24 to allow liquid to pass through. The material used in the first cathode 24 is preferably a metal less likely to be ionized by hydrogen atoms. Examples include a platinum electrode or a diamond electrode.

A cation exchange membrane 26, which is a flexible thin membrane, is arranged on the left side of the first cathode 24 so as to conform to the first cathode 24. A hermetically sealed cathode chamber 102 is demarcated by the cation exchange membrane 26 and the cation chamber recessed portion 20a. Because the cation exchange membrane 26 is a thin membrane, it has been omitted from FIG. 4A and FIG. 4B. When raw water described below flows in from the cathode chamber inlet 100, the raw water becomes alkaline electrolyzed water in the cathode chamber 102 in the primary electrolysis stage described below and is discharged from the cathode chamber outlet 104. Here, a cation exchange membrane 26 is provided so as to conform to the mesh part 30 described below, and the cation exchange membrane 26 is wavy because of the corrugation formed in the surface of the mesh part 30. The raw water passes between the cation exchange membrane 26 and the first cathode 24 in this way.

A rectangular frame-like intermediate chamber case 32 made of a resin is included in the primary electrolyzer 10. The intermediate chamber case 32 is arranged so that the opening 33 faces the left-right direction. A cylindrical intermediate chamber outlet 110 is formed in the center of the upper surface of the intermediate chamber case 32 so as to protrude upwards. As shown in FIG. 4B, a discharge passage 110a is formed in the intermediate chamber outlet 110 extending from the opening 33 to the leading end of the intermediate chamber outlet 110. Similarly, a cylindrical intermediate chamber inlet 106 is formed in the center of the bottom surface of the intermediate chamber case 32 so as to protrude downwards. An intake passage 106a is formed in the intermediate chamber inlet 106 from the leading end to the opening 33.

Double outside-inside grooves are farmed in the right surface of the intermediate chamber case 32, and an outer gasket 28 and an inner gasket 29 are accommodated inside these grooves. Similarly, double outside-inside grooves are formed in the left surface of the intermediate chamber case 32, and an outer gasket 36 and an inner gasket 37 are accommodated inside these grooves.

The anion exchange membrane 38, a sheet-like mesh part 34, the mesh part 30 explained earlier, and the cation exchange membrane 26 are stacked in this order and housed inside the intermediate chamber case 32. Because the anion exchange membrane 38 is also a thin membrane, it too has been omitted from FIG. 4A and FIG. 4B. A plurality of protruding portions 30a are formed on the left surface of mesh part 30, and a plurality of protruding portions 34a are formed in corresponding positions on the right surface of mesh part 34. When protruding portions 30a and protruding portions 34a are brought into contact with each other, space is maintained between mesh part 30 and mesh part 34. The chlorine-based electrolyte aqueous solution described below flows from the intermediate chamber inlet 106 into the hermetically sealed intermediate chamber 108 demarcated by the cation exchange membrane 26 and the anion exchange membrane 38, and is discharged from the intermediate chamber outlet 110.

The primary electrolyzer 10 includes a sheet-like anode chamber case 44 made of a resin. An anode chamber recessed portion 44a is formed in the center of the left surface of the anode chamber case 44 to serve as the inner wall of the anode chamber 114. A hole is opened in the center of the lower portion of the anode chamber recessed portion 44a. A raw water intake passage 112a is formed in the anode chamber case 44 and extends from the hole to the leading end of the anode chamber inlet 112 formed in the lower portion of the anode chamber case 44. The anode chamber outlet 116 formed in the center of the upper end of the anode chamber recessed portion 44a is a through-hole extending in the left-right direction.

A groove is formed on the right surface of the anode chamber case 44 surrounding the anode chamber recessed portion 44a, and a gasket 42 is housed in the groove. A sheet-like first anode 40 is housed in the right surface of the anode chamber case 44 so as to cover the anode chamber recessed portion 44a and the gasket 42. A tab-like terminal 40a is formed in the first anode 40 so as to protrude forward. Mesh-like holes are also formed in the first anode 40 to allow liquid to pass through. The material used in the first anode 40 can be indium oxide or platinum. In the explanation below, the first cathode 24 and the first anode 40 may be referred to collectively as the first electrodes.

A sheet-like anion exchange membrane 38 is arranged on the right side of the first anode 40 in a conforming manner, and the hermetically sealed anode chamber 114 is demarcated by the anion exchange membrane 38 and the anode chamber recessed portion 44a. When raw water enters from the anode chamber inlet 112, the raw water is turned into the acidic electrolyzed water (primary electrolyzed water) described below in the anode chamber 114 by the primary electrolysis stage described below, and the acidic electrolyzed water is discharged from the anode chamber outlet 116. The anion exchange membrane 38 conforms to mesh part 34, and the anion exchange membrane 38 is wavy because of the corrugation formed in the surface of the mesh part 34. The raw water passes between the anion exchange membrane 38 and the first anode 40 in this way.

A guide panel housing recessed portion 44b is formed on the left surface of the anode chamber case 44, and a guide panel 46 made of resin is housed inside the guide panel housing recessed portion 44b. The guide panel 46 is described in greater detail below.

In the present embodiment, the panel-like members in the primary electrolyzer 10 are arranged in parallel fashion. For example, the cathode chamber case 20 and the intermediate chamber case 32 are arranged parallel to each other so that their surfaces are perpendicular to the X1-X2 direction. Also, the intermediate chamber case 32 and the anode chamber case 44 are arranged parallel to each other so that their surfaces are perpendicular to the X1-X2 direction. The cathode chamber case 20 and the intermediate chamber case 32 are pressure-joined to each other with the X1-X2direction being the pressure joining direction. The intermediate chamber case 32 and the anode chamber case 44 are also pressure-joined to each other with the X1-X2 direction being the pressure joining direction.

The cathode chamber 102 and the intermediate chamber 108 are partitioned by the cation exchange membrane 26, and the intermediate chamber 108 and the anode chamber 114 are partitioned by the anion exchange membrane 38. The space to the right of the cation exchange membrane 26 is the cathode chamber 102, the space between the cation exchange membrane 26 and the anion exchange membrane 38 is the intermediate chamber 108, and the space to the left of the anion exchange membrane 38 is the anode chamber 114. The cation exchange membrane 26 allows cations to pass between the cathode chamber 102 and the intermediate chamber 108, and the anion exchange membrane 38 allows anions to pass between the intermediate chamber 108 and the anode chamber 114.

In the present embodiment, the first cathode 24 and the first anode 40 are connected electrically to a direct current power supply (not shown) via wiring connected to the hole formed in the terminal 24a of the first cathode 24 and to the hole formed in the terminal 40a of the first anode 40. In the primary electrolyzer 10, voltage is applied between the first cathode 24 and the first anode 40, and raw water and a chlorine-based electrolyte aqueous solution are subjected to electrolysis. This is the primary electrolysis stage.

In the present embodiment, raw water is supplied to the cathode chamber 102 from the cathode chamber inlet 100, and raw water is supplied to the anode chamber 114 from the anode chamber inlet 112. In the present embodiment, the raw water can be tap water, well water, ion-exchange water, distilled water, or RO water. In the present embodiment, ‘raw water’ is water having a total electrolyte concentration of 15 ppm or less. For example, the metal ion concentration (sodium ion concentration) in raw water can be 2 ppm or less.

In the present embodiment, high-concentration chlorine-based electrolyte aqueous solution is supplied to the intermediate chamber 108 from an intermediate chamber inlet 106 finned below the intermediate chamber 108. In the present embodiment, the chlorine-based electrolyte is an electrolyte that produces chloride ions when dissolved in water. Examples of chorine-based electrolytes include chlorides of alkali metals (for example, sodium chloride and potassium chloride), and chlorides of alkaline-earth metals (for example, calcium chloride and magnesium chloride).

In the present embodiment, the concentration of the chlorine-based electrolyte aqueous solution supplied to the intermediate chamber 108 from the intermediate chamber inlet 106 depends on the qualities of the electrolyzed water to be prepared, but is preferably as high as possible. When the chlorine-based electrolyte contained in the chlorine-based electrolyte aqueous solution is sodium chloride, the concentration of sodium chloride in the chlorine-based electrolyte aqueous solution is preferably no more than 26 mass %.

In the present embodiment, the intermediate chamber inlet 106 formed below the intermediate chamber 108 and passing through the intermediate chamber 108, and the intermediate chamber outlet 110 formed above the intermediate chamber 108 and passing through the intermediate chamber 108 are connected to piping constituting a closed water circuit. A pump (not shown) circulates the chlorine-based electrolyte aqueous solution through the closed water circuit. The intermediate chamber 108 can be considered a part of the closed water circuit.

In the primary electrolysis stage, the chlorine ions in the intermediate chamber 108 migrate through the anion exchange membrane 38 into the anode chamber 114, and the chlorine ions are converted into chlorine by the first anode 40. This produces acidic electrolyzed water (primary electrolyzed water) in the anode chamber 114. The cations in the intermediate chamber 108 migrate through the cation exchange membrane 26 into the cathode chamber 102. This produces alkaline electrolyzed water in the cathode chamber 102.

In order to obtain the primary electrolyzed water of the present disclosure, the current supplied to the first electrodes (first anode 40 and first cathode 24) during electrolysis should be from 1.0 A to 1.5 A.

The alkaline electrolyzed water produced in the cathode chamber 102 is discharged from the cathode chamber outlet 104 formed above the cathode chamber 102 and passing through the cathode chamber 102. The primary electrolyzed water produced in the anode chamber 114 is guided by the guide panel 46 into the secondary electrolyzer 12.

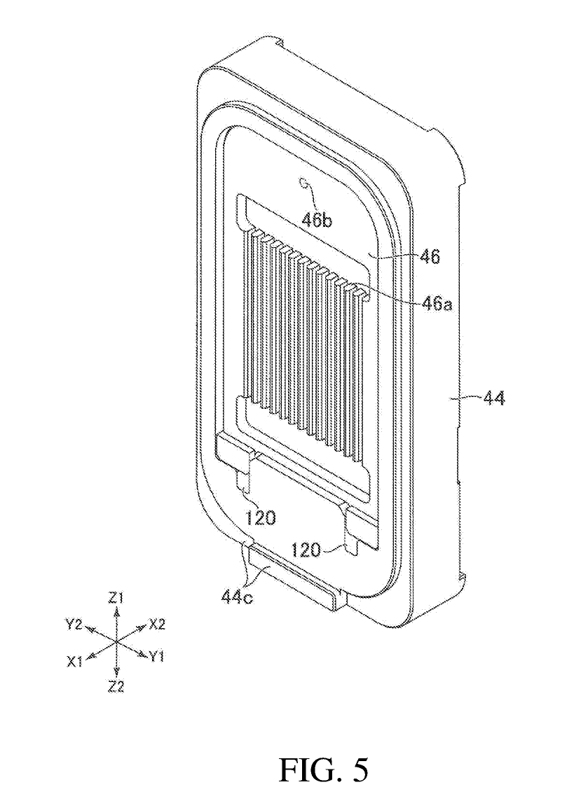

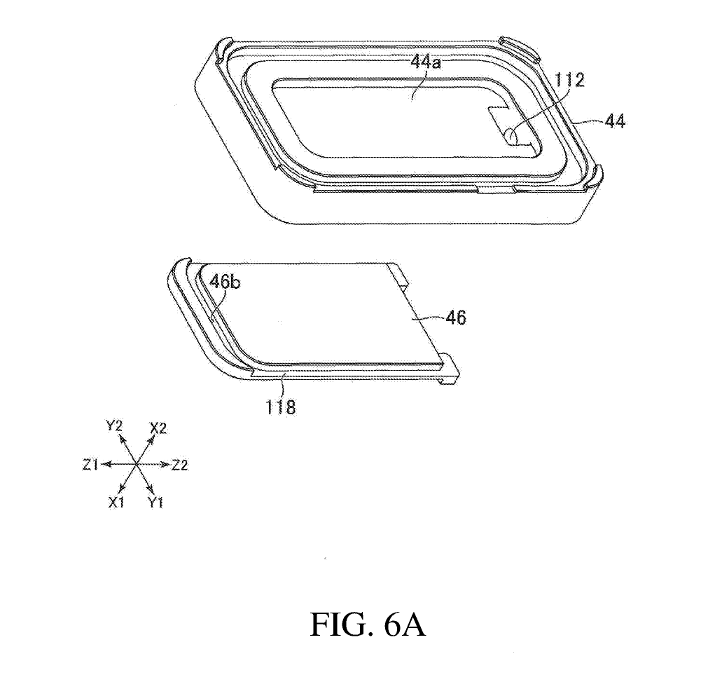

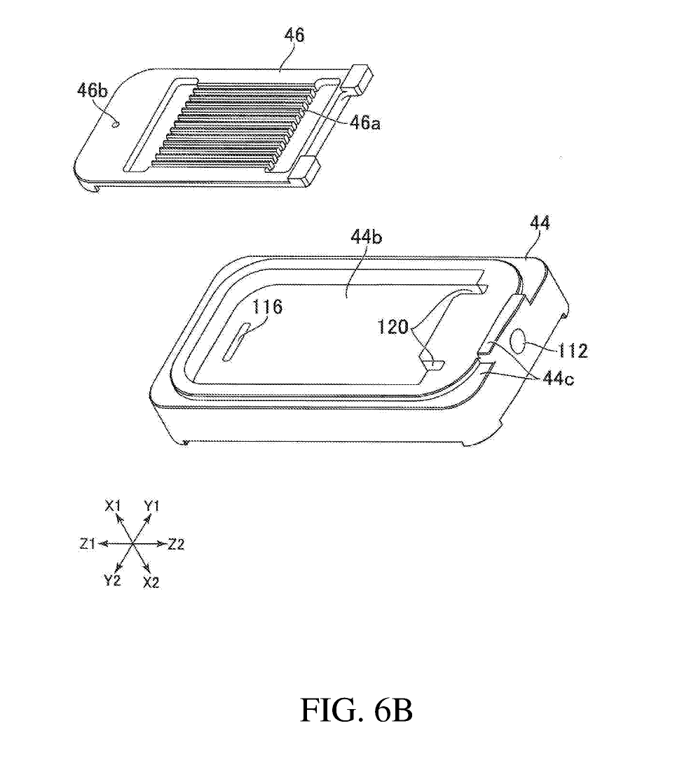

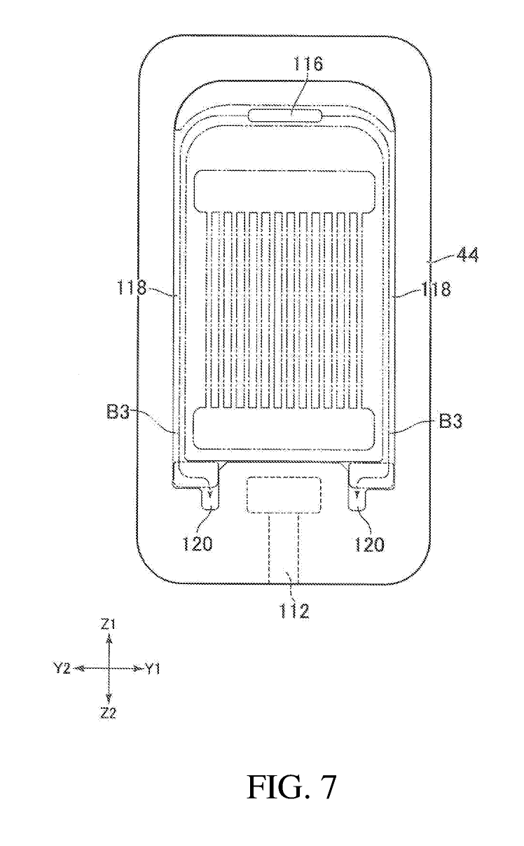

FIG. 5 is a perspective view showing the anode chamber case 44 housing a guide panel 46. FIG. 6A is an exploded perspective view of the anode chamber case 44 and guide panel 46 shown in FIG. 5. FIG. 6B is an exploded perspective view of the anode chamber case 44 and the guide panel 46 shown in FIG. 5 from a direction other than the one shown in FIG. 6A. FIG. 7 is a drawing used to explain the flow path of the primary electrolyzed water guided into the secondary electrolyzer 12 by the guide panel 46.

As shown in FIG. 6B, a primary electrolyzed water outlet 120 is formed on the front of the lower surface and the rear of the lower surface of the guide panel housing recessed portion 44b so as to protrude downward. Even when the guide panel 46 is housed in the guide panel housing recessed portion 44b, the primary electrolyzed water outlet 120 remains exposed and not covered by the guide panel 46. As shown in FIG. 6A, an upside-down U-shaped guide passage 118 is formed on the right surface of the guide panel 46. The primary electrolyzed water flowing from the anode chamber outlet 116 is discharged from the primary electrolyzed water outlet 120 via the guide passage 118. Because the primary electrolyzed water outlet 120 is connected to the reaction chamber 122 in the secondary electrolyzer 12, the primary electrolyzed water discharged from the primary electrolyzed water outlet 120 is supplied to the lower end of the secondary electrolyzer 12. As mentioned above, the guide panel 46 in the present embodiment serves as a guiding portion for guiding the primary electrolyzed water from the upper end of the primary electrolyzer 10 to the lower end of the secondary electrolyzer 12.

In the present disclosure, acidic electrolyzed water (primary electrolyzed water) is produced by the primary electrolyzer 10 composed of three chambers, namely, a cathode chamber 102, an intermediate chamber 108, and an anode chamber 114. Therefore, the acidic electrolyzed water (primary electrolyzed water) produced by the primary electrolyzer 10 in the present embodiment has a lower concentration of electrolytes than acidic electrolyzed water produced by an electrolyzer composed of two chambers, namely, a cathode chamber and an anode chamber separated by a partitioning membrane. In other words, high-purity primary electrolyzed water can be produced by the primary electrolyzer 10 in the present embodiment.

The following is an explanation of the secondary electrolyzer 12.

The secondary electrolyzer 12 includes an electrode housing case 50. An open portion 50a is formed in the right surface of the electrode housing case 50. An electrode supporting portion 78 is housed in the bottom of the open portion 50a for supporting the left edges of the second cathode 54 and the second anode 56. A plurality of panel-like second cathodes 54 and a plurality of panel-like second anodes 56 are housed in the open portion 50a. Metal ring-like second cathode spacers 62 for maintaining the interval between second cathodes 54 and metal ring-like second anode spacers 70 for maintaining the interval between second anodes 56 are also housed in the open portion 50a. A groove is formed in the peripheral edge of the open portion 50a formed on the right surface of the electrode housing case 50, and a gasket 52 is fitted into the groove. In the following explanation, the second cathodes 54 and second anodes 56 are sometimes referred to collectively as the second electrodes.

FIG. 1B shows the alternating arrangement of the seven panel-like second anodes 56 and the six panel-like second cathodes 54. Small notches are formed in the upper left, upper right, and lower left of the second cathodes 54, and a large notch is formed in the lower right. A hole 54a is also formed in the upper right of the second cathodes 54. A cathode rod 58 is passed alternatingly through the holes 54a formed in the second cathodes 54 and the hole formed in the second cathode spacers 62. Small notches are formed in the upper left, lower left, and lower right of the second anodes 56, and a large notch is formed in the upper right. A hole 56a is also formed in the lower right of the second anodes 56. An anode rod 60 is passed alternatingly through the holes 56a formed in the second anodes 56 and the hole formed in the second anode spacers 70. In the present embodiment, a second anode 56 and a second cathode 54 are arranged alternatingly on the outside, However, second cathodes 54 may be arranged on the outside, or a second cathode 54 and a second anode 56 may be arranged alternatingly on both ends.

Threading is formed in both ends of the cathode rod 58, and a nut 64c with internal threading is attached to the rear end of the cathode rod 58. The front end of the cathode rod 58 is passed through holes formed in the inner surface of a nut 64b and a gasket 66, and is then inserted into the inner surface on the rear end of the cathode rod fixing portion 68. Threading is formed on the inner surface of the nut 64b. A flange is formed on the cathode rod fixing portion 68, and internal threading is formed to the rear of the flange. The nut 64b is fastened with the gasket 66 interposed between the bottom surface of the recessed portion and the flange formed on the cathode rod fixing portion 68 to secure the cathode rod fixing portion 68 to the electrode housing case 50. Threading is formed in the outer surface of the cathode rod fixing portion 68 in front of the flange. In this way, a nut 64a is attached to the front end of the cathode rod fixing portion 68.

Threading is formed in both ends of the anode rod 60, and a nut 72c with internal threading is attached to the rear end of the anode rod 60. The front end of the anode rod 60 is passed through holes formed in the inner surface of a nut 72b and a gasket 74, and is then inserted into the inner surface on the rear end of the anode rod fixing portion 76. Threading is formed on the inner surface of the nut 72b. A flange is formed on the anode rod fixing portion 76, and internal threading is formed to the rear of the flange. A recessed portion is formed in the upper front surface of the electrode housing case 50 and a hole is formed in the bottom of the recessed portion. The nut 72b is fastened with the gasket 74 interposed between the recessed portion and the flange formed on the anode rod fixing portion 76 to secure the anode rod fixing portion 76 to the electrode housing case 50. Threading is formed in the outer surface of the anode rod fixing portion 76 in front of the flange. In this way, a nut 72a is attached to the front end of the anode rod fixing portion 76.

The open portion 50a of the electrode housing case 50 is pressure-joined in the left direction using the anode chamber case 44. The left pressure-joined surface 44c of the anode chamber case 44 shown in FIG. 5 and FIG. 6B is pressure-joined in the right direction using the electrode housing case 50. In the present embodiment, the anode chamber case 44 serves as the outer wall of the primary electrolyzer 10 pressure-joined to the open portion 50a of the secondary electrolyzer 12. In the present embodiment, the hermetically sealed reaction chamber 122 is demarcated by the anode chamber case 44 and the open portion 50a.

In the present embodiment, as shown in FIG. 1B, a plurality of grooves extending vertically are formed at a predetermined interval in the upper and lower ends of the right surface of the electrode supporting portion 78. Also, as shown in FIG. 5 and FIG. 6B, a plurality of grooves extending vertically are formed at a predetermined interval in the left surface, that is, the surface on the open portion 50a side of the guide panel 46. The right edges of the second cathodes 54 and the second anodes 56 engage the grooves 46a formed in the guide panel 46, and the upper left and lower left ends of the second cathodes 54 and second anodes 56 engage the grooves formed in the electrode supporting portion 78.

A cylindrical secondary electrolyzed water outlet 124 protruding downward is formed on the left side of the upper surface of the electrode housing case 50 for discharging the secondary electrolyzed water produced in the reaction chamber 122. As shown in FIG, 4A, a discharge passage 124a is formed inside the secondary electrolyzed water outlet 124 extending from the reaction chamber 122 to the leading end of the secondary electrolyzed water outlet 124. A cylindrical ventilation port 126 is formed in the center of the upper surface of the electrode housing case 50 for discharging gases produced in the reaction chamber 122 to the outside of the reaction chamber 122. As shown in FIG. 4A, a ventilation passage 126a is formed in the ventilation port 126 from the reaction chamber 122 to the leading end of the ventilation port 126. A cap 84 housing a gasket 82 and a filter 80 is attached to the ventilation port 126, and the ventilation passage 126a is covered by the filter 80. The filter 80 in the present embodiment is a gas-liquid separation filter which allows outside air to enter the reaction chamber 122 and allows gas generated by the reaction chamber 122 to be released to the outside from the reaction chamber 122. In FIG. 4A, the discharge path for gases generated in the reaction chamber 122 to the outside is indicated by dotted-line arrow A1. In the present embodiment, liquid supplied to the reaction chamber 122 cannot pass through the filter 80 so liquid does not leak from the ventilation port 126. An intake passage 128a for alkaline electrolyzed water is formed in the right side of the bottom surface of the electrode housing case 50 extending from the reaction chamber 122 to the leading end of the alkaline electrolyzed water inlet 128 formed in the lower portion of the electrode housing case 50.

In the present embodiment, the nuts 64a, 64b, 64c, the cathode rod fixing portion 68, the cathode rod 58, the second cathode spacers 62, and the second cathodes 54 are connected to each other electrically. Also, the nuts 72a, 72b, 72c, the anode rod fixing portion 76, the anode rod 60, the second anode spacers 70, and the second anodes 56 are connected to each other electrically. In the present embodiment, the second cathodes 54 and the second anodes 56 are connected electrically to a direct current power supply (not shown) via wiring between the cathode rod fixing portion 68 and nut 64a and via wiring between the anode rod fixing portion 76 and nut 72a. In the secondary electrolyzer 12, voltage is applied between the second cathodes 54 and the second anodes 56, and the primary electrolyzed water is subjected to electrolysis. This is the secondary electrolysis stage.

In the present embodiment, the electrolyzed water subjected to electrolysis in the secondary electrolysis stage has an effective chlorine concentration of 10 ppm or more, and contains metal ions at a concentration (molar equivalent ratio) of from 1.23 to 2.54 relative to the effective chlorine concentration (where the metal ions are cations of an alkali metal or alkaline-earth metal). The primary electrolyzed water is subjected to electrolysis in the secondary electrolysis stage when the primary electrolyzed water produced by the primary electrolyzer 10 has an effective chlorine concentration of 10 ppm or more and contains metal ions at the predetermined concentration.

Here, the electrolyzed water produced by the primary electrolyzer 10 is not electrolyzed water that has an effective chlorine concentration of 10 ppm or more and contains metal ions at the predetermined concentration. In this case, the cathode chamber outlet 104 may be connected via piping to the alkaline electrolyzed water inlet 128 formed on the bottom surface of the electrode housing case 50. Here, the electrolyzed water is adjusted so as to have an effective chlorine concentration of 10 ppm or more and contains metal ions at the predetermined concentration by adding the alkaline electrolyzed water discharged from the cathode chamber outlet 104 to the water produced by the primary electrolyzer 10. The primary electrolyzed water with added alkaline electrolyzed water is then subjected to electrolysis in the secondary electrolysis stage. The amount of alkaline electrolyzed water supplied from the alkaline electrolyzed water inlet 128 has to be adjusted so that the electrolyzed water subjected to electrolysis in the secondary electrolysis stage is electrolyzed water containing the predetermined concentration of metal ions. When the cathode chamber outlet 104 and alkaline electrolyzed water inlet 128 are not connected by piping, the alkaline electrolyzed water inlet 128 is stoppered to prevent leakage of liquid into the reaction chamber 122.

In the following explanation, the electrolyzed water subjected to electrolysis in the secondary electrolysis stage (primary electrolyzed water or primary electrolyzed water with alkaline electrolyzed water added) is referred to as raw acidic electrolyzed water.

From the standpoint of eliminating solid components from the resulting secondary electrolyzed water, the ions of alkali metals and alkaline-earth metals included in the alkaline electrolyzed water are preferably metal ions (cations) derived from hydroxides, carbonates, and bicarbonates of alkali metals or alkaline-earth metals.

Here, hydroxides of alkali metals include sodium hydroxide and potassium hydroxide, carbonate salts of alkali metals include sodium carbonate and potassium carbonate, and bicarbonate salts of alkali metals include sodium bicarbonate and potassium bicarbonate. These can be used alone or in combinations of two or more. These hydroxides, carbonate salts, and bicarbonate salts of alkali metals, when used in applications such as medicines, food products, and cosmetics, are safe and do not harm the environment.

Hydroxides of alkaline-earth metals include calcium hydroxide and magnesium hydroxide, carbonate salts of alkaline-earth metals include calcium carbonate and magnesium carbonate, and bicarbonate salts of alkaline-earth metals include calcium bicarbonate and magnesium bicarbonate. These hydroxides, carbonate salts, and bicarbonate salts of alkali metals, when used in applications such as medicines, food products, and cosmetics, are safe and do not harm the environment.

In the present embodiment, the secondary electrolyzed water produced in the reaction chamber 122 can have an effective chlorine concentration of 10 ppm or more, and contain metal ions at a concentration (molar equivalent ratio) of from 0.46 to 1.95 relative to the effective chlorine concentration. The secondary electrolyzed water is then discharged from the secondary electrolyzed water outlet 124.

In order to obtain secondary electrolyzed water in the present disclosure, the current supplied to the second electrodes (second anode 56 and second cathode 54) during hydrolysis is preferably from 5 A to 10 A.

In FIG. 4A, the flow path of the supplied raw water and discharged alkaline electrolyzed water is indicated by dotted-line arrow B1. The flow path of the circulating chlorine-based electrolyte aqueous solution is indicated by dotted-line arrow B2. In FIG. 4A and FIG. 7, the flow path of the raw water supplied to the primary electrolyzer 10, guided as primary electrolyzed water to the secondary electrolyzer 12, and discharged as secondary electrolyzed water is indicated by dotted-line arrow 133.

The secondary electrolyzed water in the present embodiment has an effective chlorine concentration of 10 ppm or more, preferably of 20 ppm or more, and usually 1,000 ppm or less in order to exhibit sufficient disinfecting power. In the present disclosure, the effective chlorine concentration of the acidic electrolyzed water can be measured using a commercially available chlorine concentration measuring device.

The metal ions included in the secondary electrolyzed water of the present embodiment are cations of an alkali metal or alkaline-earth metal. Examples of alkali metals include lithium, sodium, and potassium. Sodium or potassium is preferred. Examples of alkaline-earth metals include magnesium and calcium. Calcium is preferred.

In the present disclosure, the molar equivalent ratio concentration of metal ions relative to the effective chlorine concentration, on condition that the effective chlorine concentration is 1 mol/L, is 1 when (1) the metal is monovalent (for example, an alkali metal) and the molar concentration of metal ions is 1 mol/L, and 1 when (2.) the metal is divalent (for example, an alkaline-earth metal) and the molar concentration of metal ions is 0.5 mol/L.

In the secondary electrolyzed water of the present embodiment, the pH of the secondary electrolyzed water is too low when the molar equivalent ratio concentration of metal relative to the effective chlorine concentration is less than 0.46, and the secondary electrolyzed water becomes basic when the molar equivalent ratio concentration of metal relative to the effective chlorine concentration is greater than 1.95. This also causes instability and increases the solid content of the secondary electrolyzed water. The pH value of the secondary electrolyzed water of the present embodiment can be from 3.0 to 7.0. From the standpoint of less solid content in the secondary electrolyzed water, a metal ion concentration (molar equivalent ratio) relative to the effective chlorine concentration from 0.46 to 1.95 is preferred.

In the secondary electrolyzed water of the present embodiment, the metal ion content is usually from 0.0001 ppm to 1,000 ppm (preferably from 0.001 ppm to 500 ppm). From the standpoint of less solid content, it is more preferably 300 ppm or less.

The metal ions may be added to the primary electrolyzed water in the form of a hydroxide, carbonate salt, or bicarbonate salt of an alkali metal or alkaline-earth metal.

In the present disclosure, hydroxides are compounds containing hydroxide ions (OH⁻), carbonate salts are compounds containing carbonate ions (CO₃²⁻), and bicarbonate salts are compounds containing bicarbonate ions (HCO₃⁻).

In other words, hydroxides, carbonate salts, and bicarbonate salts of alkali metals and alkaline-earth metals are electrolytes composed of cations produced by water and/or carbon dioxide, and metal ions (cations) of alkali metals or alkaline-earth metals. Secondary electrolyzed water of the present embodiment can be obtained by electrolyzing an aqueous solution containing chlorine ions, these cations, and these anions.

The pH value of the secondary electrolyzed water in the present embodiment is preferably 7.0 or less, and more preferably from 3.0 to 7.0, in order to stabilize the secondary electrolyzed water and inhibit the production of trihalomethanes. In the present disclosure, the pH value of the secondary electrolyzed water can be measured using a commercially available pH measuring device.

In the present embodiment, both a primary electrolysis stage and a secondary electrolysis stage are required. Even when the primary electrolysis stage is extended in duration, it is difficult to obtain secondary electrolyzed water from the secondary electrolysis stage which is acidic (especially with a pH from 3 to 7), in which the effective chlorine concentration is greater than 10 ppm, and in which the metal ions have a concentration (molar equivalent ratio) of from 0.46 to 1.95 relative to the effective chlorine concentration. This is because the chlorine ions in the electrolyzed water are consumed as chlorine and the effective chlorine concentration declines when the primary electrolysis stage is extended in duration.

In the present embodiment, when raw acidic electrolyzed water is subjected to electrolysis in the secondary electrolysis stage, the electrolytes in the raw acidic electrolyzed water are used to perform the electrolysis and obtain secondary electrolyzed water. In other words, in the secondary electrolysis stage, the chlorine ions in the raw acidic electrolyzed water was consumed by the electrolysis. As a result, the chlorine ion concentration in the secondary electrolyzed water is lower than the concentration of chlorine ions in raw acidic electrolyzed water. Because ionization tends to be high, metal ions remain present in the electrolyzed water, and the metal ion concentration in the secondary electrolyzed water is about the same as the concentration of metal ions in raw acidic electrolyzed water. As a result, while the chlorine ion concentration is lower, the metal ion concentration remains unchanged and secondary electrolyzed water with relatively low solid content can be obtained.

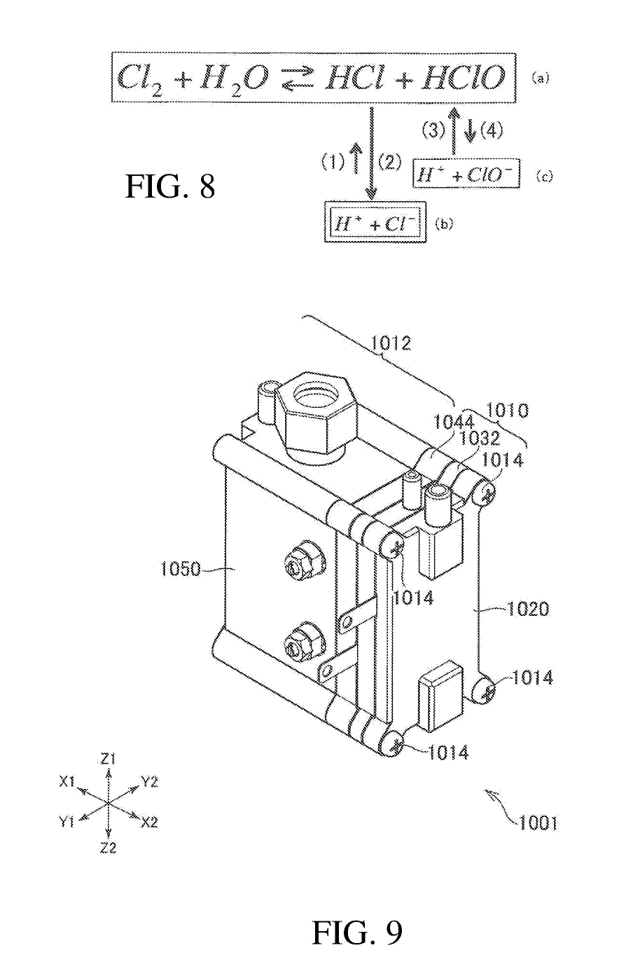

FIG. 8 is the chemical equilibrium equation in the secondary electrolyzed water of the present disclosure. Equation (a) in FIG. 8 maintains the equilibrium in the secondary electrolyzed water of the present disclosure. Hydrochloric acid (HCl) maintains the equilibrium in the directions of arrow (1) and arrow (2) between Equation (a) in FIG. 8 and Equation (b) in FIG. 8, and hypochlorous acid (HClO) maintains the equilibrium in the directions of arrow (3) and arrow (4) between Equation (a) in FIG. 8 and Equation (c) in FIG. 8. Because hydrochloric acid (HCl) is a very strong acid, it is easy to ionize and arrow (2) predominates. Because hypochlorous acid (HClO) is affected by hydrogen chloride, it is hardly ionized at all and arrow (3) predominates.

Because the acidic electrolyzed water in the present embodiment has an effective chlorine concentration of 10 ppm or more, and contains metal ions at a concentration (molar equivalent ratio) of from 0.46 to 1.95 relative to the effective chlorine concentration, side reactions can be suppressed at the cathode during electrolysis. Because this can suppress consumption of HCIO, the disinfecting effect of the secondary electrolyzed water can be maintained.

Because the concentration of HClO is maintained in the secondary electrolyzed water of the present embodiment, superior disinfecting power can be expected.

The chlorine-based electrolyte content of the secondary electrolyzed water in the present embodiment is preferably 0.1 mass % or less, more preferably 0.05 mass % or less, and even more preferably 0.025 mass % or less, in terms of sodium chloride in order to prevent corrosion of metal and the escape of chlorine gas from the secondary electrolyzed water in the present embodiment.

When the (added) chlorine-based electrolyte content of the secondary electrolyzed water in the present embodiment exceeds 0.1 mass % in terms of sodium chloride, the chloride ions bond with the hydrogen ions in the secondary electrolyzed water. As a result, the equilibrium between Equation (a) and Equation (b) in FIG. 8 is biased in the direction of arrow (1), and the equilibrium of Equation (a) in FIG. 8 is biased to the left. Consequently, the chloride ions are released as chlorine, the effective chlorine concentration of the secondary electrolyzed water is lowered, and the disinfecting effect is reduced.

The secondary electrolyzed water in the present embodiment can be used as a disinfectant and/or cleanser in various fields such as medicine, veterinary medicine, food processing, and manufacturing. It can be used to clean and disinfect tools and affected areas in medicine and veterinary medicine. The secondary electrolyzed water in the present embodiment is not unpleasant to use because it lacks a pungent odor such as the odor of halogens.

Because the secondary electrolyzed water in the present embodiment is very stable, it can be placed in a container and used as electrolyzed water inside the container.

Also, by evaporating secondary electrolyzed water of the present embodiment in air, airborne microbes can be killed. More specifically, by using secondary electrolyzed water of the present invention as the water in a humidifier, airborne microbes can be effectively killed.

Because the secondary electrolyzed water of the present embodiment has an effective chlorine concentration of 10 ppm or more, and contains metal ions at a concentration (molar equivalent ratio) of from 0.46 to 1.95 relative to the effective chlorine concentration (where the metal ions are cations of an alkali metal or alkaline-earth metal), the metal ions being cations of an alkali metal or alkaline-earth metal, electrolysis renders the electrolyzed water acidic (for example, a pH value from 3 to 7) and side reactions at the cathode are suppressed, thereby suppressing consumption of HClO. Also, because of the acidity (for example, a pH from 3 to 7), the secondary electrolyzed water of the present embodiment has disinfecting power over a long period of time and, thus, can be stored for a long period of time. The amount of solids left over after evaporation is also reduced.

In other words, the secondary electrolyzed water of the present embodiment has a metal ion concentration in a range corresponding to the effective chlorine concentration. When the effective chlorine concentration in the secondary electrolyzed water of the present embodiment is low (for example, from 10 ppm to 80 ppm), the metal ion concentration is as low as the effective chlorine concentration in a relative sense. When the effective chlorine concentration in the secondary electrolyzed water of the present embodiment is high (for example, from 100 ppm), the metal ion concentration is also higher. However, this can be diluted with water before use.

In particular, when the metal ions are derived from cations (metal ions) of a hydroxide, carbonate salt, or bicarbonate salt of an alkali metal or alkaline-earth metal, hydroxide ions (OH⁻) constituting the hydroxide, carbonate ions (CO₃²⁻) constituting the carbonate salt, and bicarbonate ions (HCO₃⁻) constituting the bicarbonate salt are derived. When the water content of the secondary electrolyzed water of the present embodiment is evaporated, water and/or gas (for example, carbon dioxide) is produced, and the solid residue left behind after the water content has evaporated is reduced.

As a result, the burden on living tissue is reduced, safety is improved, and the impact on the environment is reduced, Because the secondary electrolyzed water maintains its disinfecting power even when not stored in a dark place to avoid exposure to direct sunlight, it is easy to store.

An indicator of the long-term disinfecting power of the secondary electrolyzed water of the present disclosure is a residual chlorine concentration of 10 ppm or more, and preferably 20 ppm or more after the secondary electrolyzed water has been allowed to stand for 14 days in open air at a temperature of 22° C. and a humidity of 40%.

As an indicator of how little solid content is included in the secondary electrolyzed water of the present embodiment, the secondary electrolyzed water of the present embodiment can have a solid content of 300 ppm or less. Here, the solid content of the secondary electrolyzed water of the present embodiment is the mass of residue after 20 ml of the secondary electrolyzed water has been exposed to air for 48 hours at a temperature of 60° C. and a humidity of 30%.

When inorganic substances such as organic acids and salts of organic acids are present in secondary electrolyzed water, the organic substances are usually oxidized by chlorine and the chlorine is consumed. This reduces the disinfecting power of the secondary electrolyzed water. Because the metal ions in the secondary electrolyzed water of the present embodiment are not organic substances, they are not oxidized by chlorine. As a result, the disinfecting power of the secondary electrolyzed water is maintained over a long period of time.

The following reactions occur at the first anode 40, the first cathode 24, the second anode 56, and the second cathode 54.

### [Reactions at the First Anode 40 and the Second Anode 56]

2Cl⁻→Cl₂+2e⁻ (i) (main reaction)

4OH⁻→O₂+2H₂O+4e⁻ (ii) (side reaction)

### [Reactions at the First Cathode 24 and the Second Cathode 54]

2H⁺+2e⁻→H₂ (iii) (main reaction)

H⁺+2e⁻+HClO→2H₂O+Cl⁻ (iv) (side reaction)

The disinfecting power of acidic electrolyzed water is derived from hypochlorous acid (HClO) (Equation (a) in FIG. 8). The chlorine in the hypochlorous acid readily evaporates as it is a gas at normal temperatures. As a result, the disinfecting power of acidic electrolyzed water gradually diminishes as chlorine is lost.

In the present embodiment, a creative idea is used to suppress the loss of chlorine. The equilibrium in Equation (a) of FIG. 8 is biased to the right by reducing the amount of HCl, and the concentration of hypochlorous acid (HClO) is increased.

The reduction in HCl is one factor in the rise of the pH of the acidic electrolyzed water. In order to counter this, the method for manufacturing secondary electrolyzed water of the present embodiment suppresses the rise in pH while increasing the concentration of hypochlorous acid (HClO).

In the present embodiment, raw acidic electrolyzed water having an effective chlorine concentration of 10 ppm or more and containing metal ions (cations) at a predetermined concentration is electrolyzed in the secondary electrolyzer 12. The presence of cations easily converts hydrogen atoms (H⁺), which are less susceptible to ionization than cations, into hydrogen (H₂) (Equation (iii) progresses to the right). This can improve electrolysis efficiency.

Because the Cl⁻ generated in Equation (iv) is also converted to Cl₂, the equilibrium moves from Equation (a) in FIG. 8 towards Equation (b) in FIG. 8 as the amount of Cl⁻ is reduced, and H⁺ and is produced from HCl. In this way, the equilibrium in Equation (a) of FIG. 8 becomes biased to the right. As a result, the amount of hypochlorous acid (HClO) in the final acidic electrolyzed water of the present embodiment can be increased.

In the secondary electrolysis stage, when acidic electrolyzed water having an effective chlorine concentration of 10 ppm or more and a metal ion concentration (molar equivalent ratio) of less than 1.23 relative to the effective chlorine concentration is electrolyzed, the concentration of metal ions is low and the electrolysis does not progress adequately.

In the present embodiment, as in the case of the first electrodes, the second electrodes are arranged parallel to the pressure-joined surface of the anode chamber case 44 serving as the outer wall of the primary electrolyzer 10 and the open portion 50a of the electrode housing case 50 (pressure-joined surface 50b of the electrode housing case 50 and pressure-joined surface 44c of the anode chamber case 44). When the production device 1 is to be manufactured by pressure-joining the adjacent case components to each other, the primary electrolyzer 10 and the secondary electrolyzer 12 can be easily sealed together. When sealed together in this manner, among the second electrodes housed in the secondary electrolyzer 12, the electrodes between the electrode closest to the primary electrolyzer 10 and the electrode farthest from the primary electrolyzer 10 become inclined due to the electrolysis conditions and this causes the production efficiency of the secondary electrolyzer to decline.

In the present embodiment, as shown in FIG. 1B and FIG. 4A, each of the second electrodes are provided so that the edges of the second electrodes face the side of the primary electrolyzer 10 with the primary electrolyzed water outlet 120, that is, the left surface of the anode chamber case 44 in which the guide panel 46 is accommodated. Therefore, in the present embodiment, the second electrodes do not become inclined due to the electrolysis conditions. As a result, the present embodiment is able to maintain electrolyzed water production efficiency.

In the present embodiment, as mentioned above, the primary electrolyzer 10 and the secondary electrolyzer 12 are integrated in the production device 1. This allows the primary electrolyzer 10 and the secondary electrolyzer 12 to be easily sealed while maintaining electrolyzed water production efficiency.

In the present embodiment, each of the second electrodes is provided so that the normal direction of the electrode surface is the direction perpendicular to the vertical direction (the Z1-Z2 direction), and the direction perpendicular to the pressure joining direction (the X1-X2 direction) of the anode chamber case 44 serving as the outer wall of the primary electrolyzer and the open portion 50a of the electrode housing case 50. In other words, in the present embodiment, each of the second electrodes is provided so that the normal direction of the electrode surface is in the Y1-Y2 direction. As a result, gases generated by the secondary electrolyzer 12 can be smoothly discharged to the outside without being obstructed by the second electrodes.

In the present embodiment, among the first electrodes, the electrode in the position closest to the anode chamber case 44 is an anode. As a result, the length of the flow path for guiding the primary electrolyzed water generated in the anode chamber 114 to the secondary electrolyzer 12 can be reduced.

In the present embodiment, as mentioned above, grooves 46a are formed in the surface of the guide panel 46 with the open portion 50a, that is, on the left surface, to engage the edges of the second electrodes. As a result, the guide panel 46 not only guides the primary electrolyzed water to the secondary electrolyzer 12, it also maintains the interval at which the second electrodes are arranged.

Because the grooves 46a are formed at a predetermined interval in the present embodiment, the width of the second electrodes can be kept constant by the guide panel 46.

In the present embodiment, the repulsive force of gasket 22, outer gasket 28, inner gasket 29, outer gasket 36, inner gasket 37, gasket 42, and gasket 52 is received by outer case 14a and outer case 14b. As a result, the primary electrolyzer 10 and the secondary electrolyzer 12 can be fastened together simply by using fastening members such as screws. This reduces the cost of manufacturing the production device 1.

In the present embodiment, as shown in FIG. 4A, FIG. 5, and FIG. 6B, a hole 46b is formed in the guide panel 46 in the position where it overlaps with the anode chamber outlet 116 when viewed from the left. As shown in FIG. 4A, the hole 46b enables the primary electrolyzed water passage to communicate with a component that prevents the outflow of liquid but allows in air (filter 80 in the present embodiment).

When the production device 1 in the present embodiment has been stopped and liquid remains in the anode chamber 114, the osmotic pressure between the anode chamber 114 and the intermediate chamber 108 causes the liquid to flow from the anode chamber 114 to the intermediate chamber 108, As a result, the volume of the circulating chlorine-based electrolyte aqueous solution increases and the concentration decreases. In the production device 1 of the present embodiment, as mentioned above, the flow path of the primary electrolyzed water communicates with a component that prevents the outflow of liquid but allows in air. As a result, the air pressure of the air flowing in from the outside discharges liquid from the anode chamber 114 when the device has stopped, In FIG. 4A, the flow path of the air from the outside when the device has stopped is indicated by dotted-line arrow A2. As a result, in the production device 1 of the present embodiment, liquid can be extracted from the anode chamber 114 without requiring a complicated manual operation performed by the user.

The flow path of the alkaline electrolyzed water produced in the cathode chamber 102 can also communicate with the component that prevents the outflow of liquid but allows in air. In this case, the air pressure of the air flowing in from the outside discharges liquid from the cathode chamber 102 when the production device 1 has stopped. As a result, liquid can be extracted from the cathode chamber 102 without requiring a complicated manual operation performed by the user.

In the present embodiment, the component that prevents the outflow of liquid but allows in air also communicates with the flow path guiding the primary electrolyzed water from the primary electrolyzer 10 to the secondary electrolyzer 12. As a result, the liquid in the anode chamber 114 is removed even when the production device 1 in the present embodiment has stopped. However, the liquid is not removed from the secondary electrolyzer 12. This prevents the liquid in the secondary electrolyzer 12 from being extracted along with the liquid from the anode chamber 114 when the production device 1 in the present embodiment has stopped.

In the present embodiment, the component that prevents the outflow of liquid but allows in air uses a gas-liquid separation filter 80. In the present embodiment, outside air can flow into the reaction chamber 122 and gases produced in the reaction chamber 122 can be discharged to the outside, but liquid cannot leak from the ventilation port 126.

The present disclosure is not limited to the embodiment described above.

FIG. 9 is an external perspective view of a device 1001 for producing electrolyzed water according to another embodiment of the present disclosure. The production device 1001 shown in FIG. 9 includes a primary electrolyzer 1010 with the same configuration as primary electrolyzer 10. The production device 1001 also includes a secondary electrolyzer 1012 with the same configuration as secondary electrolyzer 12. In the production device 1001 shown in FIG. 9, the primary electrolyzer 1010 and the secondary electrolyzer 1012 are fastened together using fastening members 1014 such as screws.

Using the fastening members 1014, the cathode chamber case 1020 and the intermediate chamber case 1032 in the primary electrolyzer 1010 are pressure-joined to each other so that the pressure joining direction is the X1-X2 direction. The intermediate chamber case 1032 and the anode chamber case 1044 in the primary electrolyzer 1010 are also pressure-joined to each other so that the pressure joining direction is the X1-X2 direction. The open portion formed in the right side of the electrode housing case 1050 in the secondary electrolyzer 1012, which is similar to the electrode housing case 50, is pressure-joined in the left direction using the anode chamber case 1044 in the primary electrolyzer 1010. The anode chamber case 1044 in the primary electrolyzer 1010 is pressure-joined in the right direction using the electrode housing case 1050.

In the production device 1001 shown in FIG. 9, each of the second electrodes housed in the electrode housing case 1050 is provided so that the edges of the second electrodes face the left surface of the anode chamber case 1044, that is, the primary electrolyzed water outlet in the primary electrolyzer 1010. As a result, the second electrodes in the production device 1001 shown in FIG. 9 do not become inclined due to the electrolysis conditions. As a result, the electrolyzed water production efficiency of the production device 1001 shown in FIG. 9 can be maintained.

The production device 1001 with an integrated primary electrolyzer 1010 and secondary electrolyzer 1012 shown in FIG. 9, as in the case of production device 1, enables the primary electrolyzer 1010 and the secondary electrolyzer 1012 to be easily sealed while maintaining electrolyzed water production efficiency.

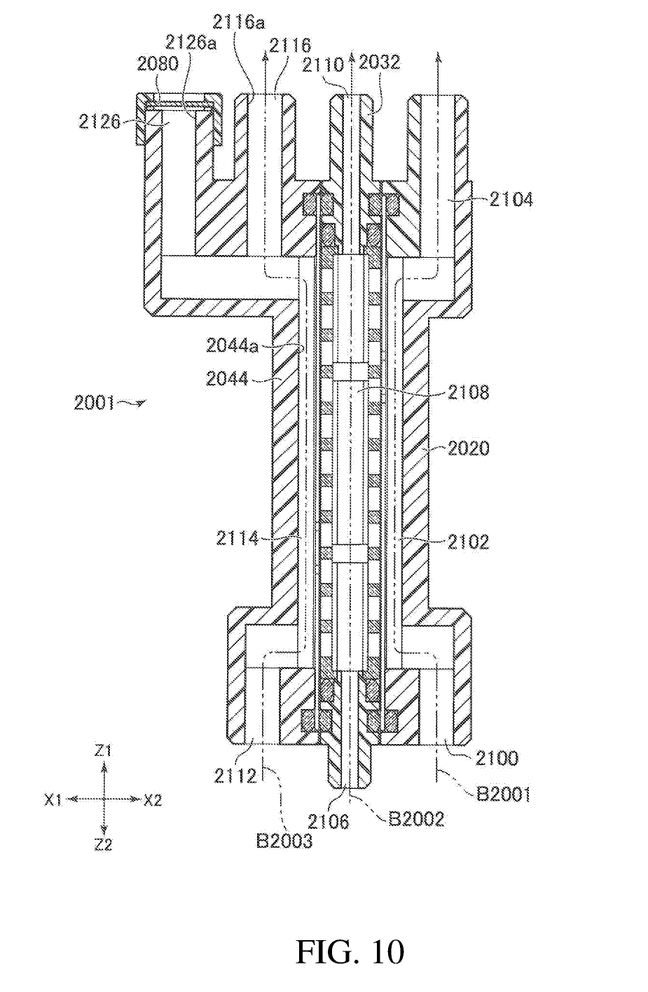

FIG. 10 is a cross-sectional view of a device 2001 for producing electrolyzed water according to another embodiment of the present disclosure. In FIG. 10, a vertical cross-section of the production device 2001 in the direction perpendicular to the Y1-Y2 direction is viewed from the front (the Y1 direction).

The production device 2001 shown in FIG, 10 includes a cathode chamber case 2020 with the same configuration as cathode chamber case 20, an intermediate chamber case 2032 with the same configuration as intermediate chamber case 32, and a cathode chamber case 2044 with the same configuration as anode chamber case 44. The cathode chamber case 2020 and the intermediate chamber case 2032 are pressure-joined to each other with the X1-X2 direction being the pressure joining direction. The intermediate chamber case 2032 and the cathode chamber case 2044 are also pressure-joined to each other with the X1-X2 direction being the pressure joining direction.

An anode chamber recessed portion 2044a serving as the inner wall of the anode chamber 2114 is formed in the center of the right surface of the cathode chamber case 2044. A ventilation port 2126 and an anode chamber outlet 2116 are arranged side-by-side left to right in the central upper portion of the left surface of the cathode chamber case 2044 and protrude outward. A discharge passage 2116a extending to the central upper portion of the anode chamber recessed portion 2044a is formed inside the anode chamber outlet 2116. A ventilation passage 2126a extending from the discharge passage 2116a to the leading end of the ventilation port 2126 is formed inside the ventilation port 2126.

The cathode chamber 2102 and the intermediate chamber 2108 are partitioned by a cation exchange membrane, and the intermediate chamber 2108 and the anode chamber 2114 are partitioned by an anion exchange membrane. The space to the right of the cation exchange membrane is the cathode chamber 2102, the space between the cation exchange membrane and the anion exchange membrane is the intermediate chamber 2108, and the space to the left of the anion exchange membrane is the anode chamber 2114.

When raw water described below flows in from the cathode chamber inlet 2100, the raw water becomes alkaline electrolyzed water in the cathode chamber 2102 in the primary electrolysis stage and is discharged from the cathode chamber outlet 2104, When raw water flows in from the anode chamber inlet 2112, the raw water becomes acidic electrolyzed water in the anode chamber 2114 in the primary electrolysis stage and is discharged from the anode chamber outlet 2116.

The intermediate chamber inlet 2106 formed below the intermediate chamber 2108 and passing through the intermediate chamber 2108, and the intermediate chamber outlet 2110 formed above the intermediate chamber 2108 and passing through the intermediate chamber 2108 are connected to piping constituting a closed water circuit. A pump (not shown) circulates the chlorine-based electrolyte aqueous solution through the closed water circuit. The intermediate chamber 2108 can be considered a part of the closed water circuit.

The chlorine ions in the intermediate chamber 2108 migrate through the anion exchange membrane into the anode chamber 2114, and the chlorine atoms are converted into chlorine by the first anode. This produces acidic electrolyzed water (primary electrolyzed water) in the anode chamber 2114. The cations in the intermediate chamber 2108 migrate through the cation exchange membrane into the cathode chamber 2102. This produces alkaline electrolyzed water in the cathode chamber 2102.

The alkaline electrolyzed water produced in the cathode chamber 2102 is discharged from the cathode chamber outlet 2104 formed upwards in the cathode chamber 2102 and passing through the cathode chamber 2102. The acidic electrolyzed water produced in the anode chamber 2114 is discharged from the anode chamber outlet 2116 formed upwards in the anode chamber 2114 and passing through the anode chamber 2114.

In FIG. 10, the flow path of the supplied raw water and discharged alkaline electrolyzed water is indicated by dotted-line arrow B2001. The flow path of the circulating chlorine-based electrolyte aqueous solution is indicated by dotted-line arrow B2002. The flow path of the supplied raw water and discharged acidic electrolyzed water is indicated by dotted-line arrow B2003.

As shown in FIG. 10, the flow path 132003 of the acidic electrolyzed water communicates with a component that prevents the outflow of liquid but allows in air (filter 2080 in FIG. 10).

In production device 2001 shown in FIG. 10, because the flow path of the acidic electrolyzed water communicates with a component that prevents the outflow of liquid but allows in air, the liquid is extracted from the anode chamber 2114 when the device is stopped by the pressure of the air flowing in from the outside. As a result, in the production device 2001 shown in FIG. 10, liquid can be extracted from the anode chamber 2114 without requiring a complicated manual operation performed by the user.

The flow path of the alkaline electrolyzed water produced in the cathode chamber 2102 can also communicate with a component that prevents the outflow of liquid but allows in air. Here, the liquid is extracted from the cathode chamber 2102 when the production device 2001 is stopped by the pressure of the air flowing in from the outside. In other words, liquid can be extracted from the cathode chamber 2102 without requiring a complicated manual operation performed by the user.

The component that prevents the outflow of liquid but allows in air does not have to be a gas-liquid separation filter. For example, the component can be a check valve that allows in gas and liquid from outside but prevents the flow of gas and liquid to the outside.

1. A device for producing electrolyzed water comprising:
a primary electrolyzer for obtaining acidic primary electrolyzed water by performing electrolysis on raw water and a chlorine-based electrolyte aqueous solution, and
a secondary electrolyzer for obtaining secondary electrolyzed water by performing electrolysis on the primary electrolyzed water or by performing electrolysis on primary electrolyzed water to which alkaline electrolyzed water has been added,
the primary electrolyzer comprising a plurality of first electrodes for electrolyzing the raw water and chlorine-based electrolyte aqueous solution,
the secondary electrolyzer comprising a plurality of second electrodes for electrolyzing the primary electrolyzed water or primary electrolyzed water to which alkaline electrolyzed water has been added,
an outer wall of the primary electrolyzer being pressure joined with an open portion formed in the second electrolyzer,
each of the first electrodes being provided parallel to the pressure joined surface of the outer wall of the primary electrolyzer and the open portion, and
each of the second electrodes being provided so that the edges of the second electrodes face the outlet for the primary electrolyzed water in the primary electrolyzer.

2. A device for producing electrolyzed water according to claim 1, wherein each of the second electrodes are provided so that the normal direction of the electrode surface is the direction perpendicular to the vertical direction, and the direction perpendicular to the pressure joining direction of the outer wall of the primary electrolyzer and the open portion.

3. A device for producing electrolyzed water according to claim 1, wherein the first electrode in the position closest to the outer wall is an anode.

4. A device for producing electrolyzed water according to claim 1, wherein grooves for engaging the edges of the second electrodes are formed in the open ended surface of a guiding portion accommodated in the outer wall of the primary electrolyzer for guiding the primary electrolyzed water into the secondary electrolyzer.

5. A device for producing electrolyzed water according to claim 4, wherein the grooves are formed at a predetermined interval.
